(19) United States
(12) Patent Application Publication
(10) Pub. No.: US 2013/0230686 A1
(43) Pub. Date: Sep. 5, 2013

(54) SLIM CARPET TILE HAVING EXCELLENT DIMENTIONAL STABILITY, AND METHOD FOR MANUFACTURING SAME

(71) Applicant: Maru Jeon, Cheongju-si (KR)

(72) Inventor: Maru Jeon, Cheongju-si (KR)

(21) Appl. No.: 13/884,252

(22) PCT Filed: Nov. 7, 2011
(86) PCT No.: PCT/KR2011/008421

§ 371 Date: May 8, 2013

(30) Foreign Application Priority Data
Nov. 9, 2010 (KR) 10-2010-0110933

(51) Int. Cl. A47G 27/02; B32B 37/14

(52) U.S. Cl. CPC A47G 27/02; B32B 37/14
USPC 428/96; 156/148

(57) ABSTRACT

Provided is a carpet tile having a minimized tri-layer structure consisting of a fiber layer, a non-woven fabric layer, and a polyvinyl chloride resin layer. The carpet tile having excellent dimensional stability according to the present invention is characterized by comprising, starting from the top thereof, a surface treatment layer, a fiber layer, a non-woven fabric layer, and a polyvinyl chloride resin layer, wherein the non-woven fabric layer comprises a mixture of polyethylene terephthalate (PET) and glass fibers.

### TECHNICAL FIELD

The present invention relate to a carpet tile and a method for manufacturing the same, and more particularly, to a slim carpet tile, which is formed by stacking a non-woven fabric layer of high strength on a vinyl chloride resin layer to reduce stacking thickness while ensuring excellent dimensional stability, and a method for manufacturing the same.

### BACKGROUND ART

A carpet tile is composed of a fiber layer, which constitutes a flooring finish surface, and a backing layer configured to provide construction adaptability and dimensional stability. A carpet tile has a square shape, each side of which has a length of about 50˜100 cm, permits easier maintenance than a typical roll-type carpet, and is capable of providing various unique tile patterns. Thus, the carpet tile is used as a flooring finish material suited for interior sites requiring a comfortable and snug atmosphere, and school buildings, libraries, meeting rooms and interior pedestrian passages, which require impact absorbing properties.

FIG. 1 is a schematic sectional view of a typical carpet tile.

Referring to FIG. 1, a typical carpet tile 1 may include a surface treatment layer 10, a fiber layer 20, a non-woven fabric layer 30, a first vinyl chloride resin layer 40, a glass fiber layer 50 and a second vinyl chloride resin layer 60 from the top of the tile.

However, since the carpet tile 1 has a five-layer structure in which the fiber layer 20, the non-woven fabric layer 30, the first vinyl chloride resin layer 40, the glass fiber layer 50, and the second vinyl chloride resin layer 60 are stacked from the top of the structure, the carpet tile 1 has demerits such as thick thickness and high manufacturing cost.

### DISCLOSURE

### Technical Problem

An aspect of the present invention is to provide a carpet tile of a tri-layer structure, which includes a fiber layer, a non-woven fabric layer and a vinyl chloride resin layer from the top of the structure, and a method for manufacturing the same.

Another aspect of the present invention is to provide a carpet tile, which is formed by stacking a non-woven fabric layer of high strength on a vinyl chloride resin layer to reduce stacking thickness to obtain a slim structure while ensuring excellent dimensional stability, and a method for manufacturing the same.

### Technical Solution

In accordance with one aspect of the present invention, a carpet tile includes a surface treatment layer, a fiber layer, a non-woven fabric layer and a vinyl chloride resin layer from the top of the tile, wherein the non-woven fabric layer is comprised of a mixture of polyethylene terephthalate (PET) and glass fibers.

In accordance with another aspect of the present invention, a method for manufacturing a carpet tile includes: forming a fiber layer by weaving yarns on an upper surface of a non-woven fabric layer comprised of a mixture of polyethylene terephthalate (PET) and glass fibers; forming a surface treatment layer by spray coating a fluorine-based surface treating agent on a surface of the fiber layer; and attaching a vinyl chloride resin layer to a lower surface of the non-woven fabric layer.

### Advantageous Effects

The slim carpet tile according to the present invention adopts a minimized tri-layer structure constituted by a fiber layer, a non-woven fabric layer and a vinyl chloride resin layer from the top of the structure, instead of a five-layer structure of a typical carpet tile constituted by a fiber layer, a non-woven fabric layer, a first vinyl chloride resin layer, a glass fiber layer and a second vinyl chloride resin layer from the top of the structure, thereby enabling reduction in manufacturing cost.

Further, the slim carpet tile according to the present invention employs non-woven fabrics comprised of a mixture of polyethylene terephthalate and glass fibers and thus can secure high strength and a plush appearance, thereby satisfying dimensional stability according to KS K 2621 while preventing curling of tile due to humidity.

### DESCRIPTION OF DRAWINGS

FIG. 1 is a schematic sectional view of a typical carpet tile.

FIG. 2 is a schematic sectional view of a carpet tile in accordance with one embodiment of the present invention.

FIG. 3 is a flowchart of a method for manufacturing a carpet tile in accordance with one embodiment of the present invention.

### BEST MODE

The above and other aspects, features, and advantages of the present invention will become apparent from the detailed description of the following embodiments in conjunction with the accompanying drawings. It should be understood that the present invention is not limited to the following embodiments and may be embodied in different ways, and that the embodiments are given to provide complete disclosure of the invention and thorough understanding of the present invention to those skilled in the art. The scope of the present invention is defined only by the claims. Like reference numerals indicate like elements throughout the specification and drawings.

Now, a slim carpet tile having excellent dimensional stability and a method for manufacturing the same according to the present invention will be described with reference to the accompanying drawings.

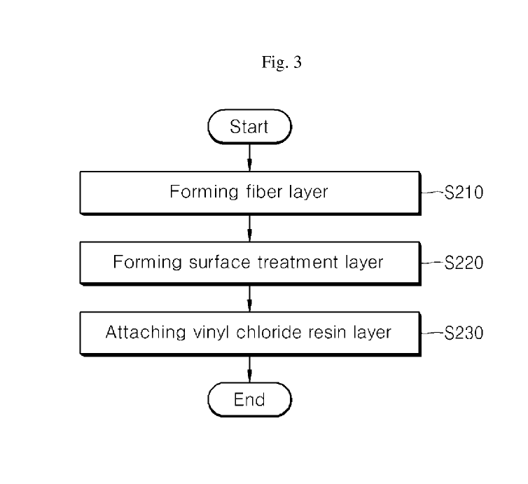

FIG. 2 is a schematic sectional view of a carpet tile in accordance with one embodiment of the present invention.

Referring to FIG. 2, a slim carpet tile 100 having excellent dimensional stability according to the present embodiment incudes a surface treatment layer 110, a fiber layer 120, a non-woven fabric layer 130, and a vinyl chloride resin layer 140 sequentially from the top of the carpet tile.

The surface treatment layer 110 may be formed by spray coating a surface treating agent on a yarn surface of the fiber layer 120. Here, the surface treating agent may be a fluorine-based surface treating agent having water-repellent and anti-fouling properties, which contains, for example, a fluorinated acrylic copolymer, glycol, water, and the like.

The fiber layer 120 is comprised of a plurality of piles woven on the non-woven fabric layer 130, and each pile is formed by weaving several strands of yarns (fiber). Here, the fiber layer 120 may be formed of yarns, which contain 5 to 20 parts by weight of carbon fibers based on 100 parts by weight of general fibers.

The general fibers may be natural fibers or synthetic fibers, for example, polyester fibers, polypropylene fibers, nylon fibers, polystyrene fibers, acryl fibers, cellulose fibers, and the like. The carbon fibers serve to impart antistatic properties.

If the carbon fibers are present in an amount of less than 5 parts by weight based on 100 parts by weight of the general fibers, the fiber layer provides insignificant antistatic properties, and if the carbon fibers are present in an amount of greater than 20 parts by weight based on 100 parts by weight of the general fibers, there can be a problem of cost increase due to excess of the carbon fibers.

Advantageously, the piles constituting the fiber layer 120 may have a height ranging from 2 mm to 15 mm, without being limited thereto. The fiber layer 120 provides a textile outward appearance through the piles formed by weaving several strands of yarns, thereby improving walking conditions while reducing fatigue.

Piles can be classified into a loop type pile and a cut type pile. Here, the loop type pile refers to a pile which is formed by twisting several strands of yarn and has a ring-shaped end. On the other hand, the cut type pile refers to a pile which is obtained by vertically gathering several strands of yarn and has a horizontally cut plane at a tip thereof. At this time, the fiber layer may consist of loop type piles, cut type piles, or combinations thereof.

The non-woven fabric layer 130 serves as a substrate for weaving the yarns to form the fiber layer 120, and acts to secure dimensional stability. The non-woven fabric layer 130 is comprised of a mixture of polyethylene terephthalate (PET) and glass fibers.

Specifically, in the non-woven fabric layer 130, the glass fibers may be present in an amount of 20˜50 parts by weight based on 100 parts by weight of polyethylene terephthalate (PET).

If the glass fibers are present in an amount of less than 20 parts by weight based on 100 parts by weight of polyethylene terephthalate (PET), the non-woven fabric layer is has poor strength, thereby making it difficult to secure dimensional stability. If the glass fibers are present in an amount of greater than 50 parts by weight based on 100 parts by weight of polyethylene terephthalate (PET), fine holes of the non-woven fabric layer 130 are enlarged due to the excess of the glass fibers, thereby making it difficult to weave the yarns of the fiber layer 120 thereon.

The vinyl chloride resin layer 140 may be constituted by a vinyl chloride resin sol layer or a vinyl chloride resin sheet layer.

Specifically, the vinyl chloride resin layer 140 includes 30 to 80 parts by weight of a plasticizer, 5 to 30 parts by weight of a smoke density reducing agent, 100 to 500 parts by weight of fillers, and 20 to 40 parts by weight of carbon black, based on 100 parts by weight of a vinyl chloride resin. Here, the vinyl chloride resin may have a degree of polymerization of about 1,500.

Examples of the plasticizer include dioctyl phthalate (DOP), dioctyl adipate (DOA), tricresyl phosphate (TCP), and the like, and examples of the fillers include calcium carbonate, calcium bicarbonate, and the like.

Further, the vinyl chloride resin layer 140 may include the smoke density reducing agent for the purpose of reducing smoke density. The smoke density reducing agent may be at least one of magnesium hydroxide, aluminum hydroxide, and a mixture thereof. The smoke density reducing agent may be subjected to surface treatment using stearic acid to retard an initial combustion time and a smoking speed of a base resin while improving flame retardancy, mechanical properties and processibility.

The smoke density reducing agent may be added in an amount of 5 to 30 parts by weight based on 100 parts by weight of the vinyl chloride resin. If the amount of the smoke density reducing agent is less than 5 parts by weight, it is difficult to obtain desired flame retardancy and to retard the smoking speed, and if the amount of the smoke density reducing agent exceeds 30 parts by weight, there is a problem of deterioration in mechanical strength.

Further, the vinyl chloride resin layer 140 may include a small amount of carbon black to impart antistatic properties. The carbon black may be present in an amount of 10 to 50 parts by weight based on 100 parts by weight of the vinyl chloride resin.

If the amount of the carbon black is less than 10 parts by weight, the vinyl chloride resin layer exhibits insignificant antistatic properties, and if the amount of the carbon black exceeds 50 parts by weight, there is a problem of cost increase due to excess use of the carbon black.

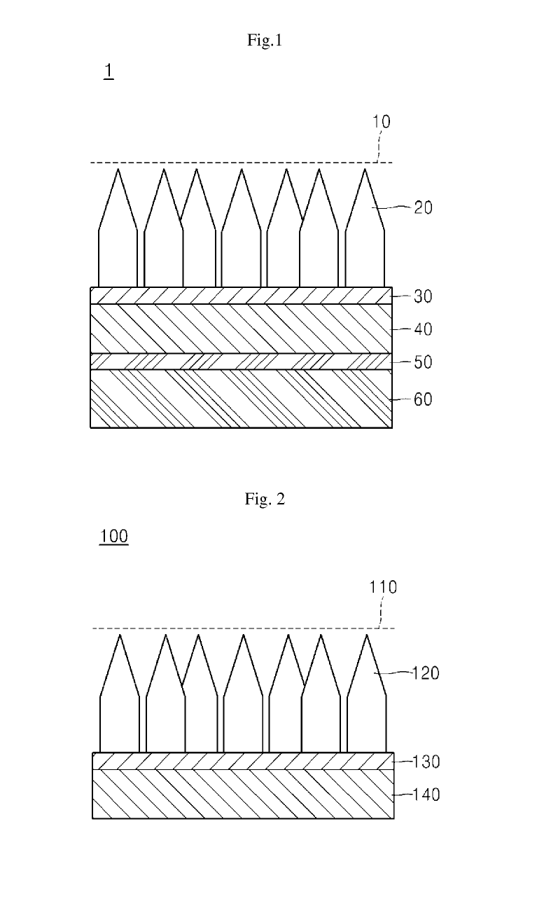

The slim carpet tile according to the present embodiment has a tri-layer structure, which consists of the fiber layer, the non-woven fabric layer and the vinyl chloride resin layer from the top of the structure, except for the surface treatment layer. Here, in the typical carpet tile shown in FIG. 1, the glass fiber layer acts to impart dimensional stability, and thus has a 5-layer structure by additionally stacking the vinyl chloride resin layer under the glass fiber layer in order to prevent a rear side of the glass fiber layer from being exposed.

Unlike the structure of the typical carpet tile, the carpet tile according to the present embodiment is formed by stacking the non-woven fabric layer, which is comprised of the mixture of polyethylene terephthalate (PET) and the glass fibers on the vinyl chloride resin layer to have high strength and a plush appearance, thereby securing dimensional stability while minimizing the number of layers in the layered structure by eliminating the glass fiber layer.

Accordingly, the carpet tile according to the embodiment of the invention has a minimized tri-layer structure to achieve a reduction in thickness to about 5 mm, thereby enabling slim products while reducing manufacturing costs.

### Method of Manufacturing Carpet Tile

FIG. 3 is a flowchart of a method for manufacturing a carpet tile in accordance with one embodiment of the present invention.

Referring to FIG. 2 and FIG. 3, in a process of forming a fiber layer (S210), a fiber layer 120 is formed by weaving yarns on an upper surface of a non-woven fabric layer 130 comprised of a mixture of polyethylene terephthalate (PET) and glass fibers.

The non-woven fabric layer 130 serves as a substrate for weaving the yarns to form the fiber layer 120, and acts to secure dimensional stability. In the non-woven fabric layer 130, the glass fibers may be present in an amount of 20˜50 parts by weight based on 100 parts by weight of polyethylene terephthalate (PET).

The fiber layer 120 is comprised of a plurality of piles woven on the non-woven fabric layer 130, and each pile is formed by weaving several strands of yarns (fiber). Here, the fiber layer 120 may be formed of yarns, which contain 10 to 30 parts by weight of carbon fibers based on 100 parts by weight of general fibers.

Then, in a process of forming a surface treatment layer (S220), the surface treatment layer 110 is formed by spray coating a surface treating agent on a surface of the fiber layer 120.

Here, the surface treating agent may be a fluorine-based surface treating agent having water-repellent and anti-fouling properties, which contains, for example, a fluorinated acrylic copolymer, glycol, water, and the like.

Although not shown in the drawings, in the process of forming a surface treatment layer (S220), foaming may be carried out instead of spray coating. Foaming has an advantage in that excess use of the surface treating agent can be prevented by spraying the surface treating agent to selected locations on the surface of the fiber layer 120 in a foam spray manner instead of spraying the surface treating agent on the overall surface of the fiber layer 120.

Then, in a process of attaching a vinyl chloride resin layer (S230), a vinyl chloride resin layer 140 is attached to a lower surface of the non-woven fabric layer 130 opposite the upper surface of the non-woven fabric layer on which the fiber layer 120 is formed.

The vinyl chloride resin layer 140 may include 30 to 80 parts by weight of a plasticizer, 5 to 30 parts by weight of a smoke density reducing agent, 100 to 500 parts by weight of fillers, and 20 to 40 parts by weight of carbon black, based on 100 parts by weight of vinyl chloride resin. Here, the vinyl chloride resin may have a degree of polymerization of about 1,500.

In this way, a slim carpet tile having excellent dimensional stability according to the embodiment of the invention may be manufactured.

The carpet tile manufactured by the method according to the embodiment as described above is formed by stacking the non-woven fabric layer, which is comprised of the mixture of polyethylene terephthalate (PET) and the glass fibers on the vinyl chloride resin layer to have high strength and a plush appearance, thereby securing dimensional stability while minimizing the number of layers in the layered structure by eliminating the glass fiber layer.

Accordingly, the carpet tile according to the embodiment of the invention has a minimized tri-layer structure to achieve a reduction in thickness to about 5 mm, thereby enabling slimness of products while reducing manufacturing costs.

### EXAMPLES

Table 1 shows results of measuring dimensional stability, curling due to heat and humidity, and smoke density of carpet tiles prepared in one example and a comparative example.

Here, in the inventive example, a surface treatment layer was formed by spray-coating a fluorine-based surface treating agent containing an acrylic copolymer on a surface of a fiber layer. The fiber layer was formed by weaving yarns, comprised of 100 parts by weight of polyester fibers and 20 parts by weight of carbon fibers. A non-woven fabric layer was comprised of 70 parts by weight of polyethylene terephthalate and 30 parts by weight of glass fibers. The vinyl chloride resin layer was a vinyl chloride resin sol layer, which was comprised of 100 parts by weight of a vinyl chloride resin having a degree of polymerization of 1,500, 70 parts by weight of dioctyl phthalate as a plasticizer, 300 parts by weight of calcium bicarbonate fillers, 30 parts by weight of carbon black as a conducive material, and 15 parts by weight of aluminum hydroxide as a smoke density reducing agent.

In the comparative example, the vinyl chloride resin sol layer, the surface treatment layer and the fiber layer were the same as in the inventive example, and the non-woven fabric layer was comprised of 100 parts by weight of terephthalate. Further, a glass fiber layer was formed on a lower surface of the vinyl chloride resin layer.

TABLE 1

| | | Comparative | |
|---|---|---|---|
| Division | Example | Example | Reference value |
| Dimensional stability | 0.05% | 0.06% | Within 0.1% |
| Curling due to heat | 0.5 mm | 1.2 mm | 1.5 mm or less |
| and humidity | | | |
| Smoke density (Ds) | 200 | 350 | 400 or less |

Referring to Table 1, it can be seen that the carpet tile of the inventive example has lower values in terms of dimensional stability, curling due to heat and humidity, and smoke density than reference values. Thus, it can be seen that the carpet tile of the inventive example has better effects than the comparative example.

Thus, the carpet tile satisfies dimensional stability according to KS K 2621, and has a tri-layered structure including a fiber layer, a non-woven fabric layer and a vinyl chloride resin layer from the top of the structure, thereby achieving reduction in thickness of the structure while reducing manufacturing costs.

Although some embodiments have been described herein, it will be understood by those skilled in the art that these embodiments are provided for illustration only, and various modifications, changes, alterations and equivalent embodiments can be made without departing from the scope of the present invention. Therefore, the scope and sprit of the present invention should be defined only by the accompanying claims and equivalents thereof.

1. A slim carpet tile having excellent dimensional stability, comprising: a surface treatment layer, a fiber layer, a non-woven fabric layer and a vinyl chloride resin layer from top of the tile, wherein the non-woven fabric layer comprises a mixture of polyethylene terephthalate (PET) and glass fibers.

2. The slim carpet tile according to claim 1, wherein the non-woven fabric layer comprises 20 to 50 parts by weight of the glass fibers based on based on 100 parts by weight of the polyethylene terephthalate.

3. The slim carpet tile according to claim 1, wherein the vinyl chloride resin layer comprises 30 to 80 parts by weight of a plasticizer, 5 to 30 parts by weight of a smoke density reducing agent, 100 to 500 parts by weight of fillers, and 20 to 40 parts by weight of carbon black, based on 100 parts by weight of a vinyl chloride resin.

4. The slim carpet tile according to claim 1, wherein the surface treatment layer is formed using a fluorine-based surface treating agent.

5. The slim carpet tile according to claim 1, wherein the fiber layer is formed of yarns comprising a mixture of 100 parts by weight of general fibers and 5 to 20 parts by weight of carbon fibers.

6. A method of manufacturing a slim carpet tile having excellent dimensional stability, comprising:
forming a fiber layer by weaving yarns on an upper surface of a non-woven fabric layer comprised of a mixture of polyethylene terephthalate (PET) and glass fibers;
forming a surface treatment layer by spray coating a fluorine-based surface treating agent on a surface of the fiber layer; and
attaching a vinyl chloride resin layer to a lower surface of the non-woven fabric layer.

7. The method according to claim 6, wherein the non-woven fabric layer comprises 20 to 50 parts by weight of the glass fibers based on based on 100 parts by weight of the polyethylene terephthalate.

8. The method according to claim 6, wherein the fiber layer is formed of yarns comprising a mixture of 100 parts by weight of general fibers and 5 to 20 parts by weight of carbon fibers.
